(19) United States
(12) Patent Application Publication
(10) Pub. No.: US 2023/0029700 A1
(43) Pub. Date: Feb. 2, 2023

(54) MEASURING DEVICE AND MEASURING METHOD

(71) Applicant: NIPPON TELEGRAPH AND TELEPHONE CORPORATION, Chiyoda-ku, Tokyo (JP)

(72) Inventors: Atsushi ARATAKE, Musashino-shi, Tokyo (JP); Masafumi NAKAGAWA, Musashino-shi, Tokyo (JP); Daiki KOBAYASHI, Musashino-shi, Tokyo (JP); Yuta IKEGUCHI, Musashino-shi, Tokyo (JP)

(73) Assignee: NIPPON TELEGRAPH AND TELEPHONE CORPORATION, Chiyoda-ku, Tokyo (JP)

(21) Appl. No.: 17/758,700

(22) PCT Filed: Jan. 20, 2020
(86) PCT No.: PCT/JP2020/001648

§ 371 Date: Jul. 13, 2022

(51) Int. Cl. G01H 9/00

(52) U.S. Cl. CPC G01H 9/00

(57) ABSTRACT

A measurement apparatus (100) includes a laser light source (11), a beep splitter (121), an optical path converter (122), and a light reception unit (111). The beep splitter (121) branches laser light emitted from the laser light source (11) into first branch light and second branch light and irradiates a target object (1) with the first branch light. The optical path converter (122) converts a direction of the second branch light to a direction in which a structure (2) is irradiated with the second branch light and irradiates the structure (2) with the second branch light. The light reception unit (111) receives first reflected light obtained in a manner that the first branch light is reflected by the target object (1) and second reflected light obtained in a manner that the second branch light is reflected by the structure (2).

### TECHNICAL FIELD

The present disclosure relates to a measurement apparatus and a measurement method.

### BACKGROUND ART

In a complex in which an accessory attached to (supported by) a structure such as a building is provided on at least one surface of a top surface, a side surface, or a bottom surface of the building, it is necessary to measure the vibration inherent to the accessory with high accuracy (see, for example, PTL 1).

### CITATION LIST

### Patent Literature

PTL 1: JP 5-164748 A

### SUMMARY OF THE INVENTION

### Technical Problem

In the related art, in order to evaluate the vibration of the accessory in the complex described above, the accessory is set as a target object of measurement, and the vibration of only the target object is measured using an acceleration sensor or a laser Doppler vibrometer (LDV: Laser Doppler Velocimeter).

FIG. 1 is a diagram illustrating measurement of vibration of a target object 1 with an LDV 10 in the related art. The LDV 10 is a vibrometer capable of measuring the vibration of the target object 1 from a remote place in a non-contact manner. The measurement distance of the LDV 10 is 0.1 m to 100 m, for example.

The LDV 10 emits laser light having a frequency v and irradiates the target object 1. The target object 1 vibrates at a frequency f. The frequency of reflected light obtained in a manner that the laser light is reflected by the target object 1 is shifted by the Doppler shift Δv due to the vibration of the target object 1. Thus, the frequency of the reflected light is (v+Δv).

The LDV 10 receives the reflected light from the target object 1. The LDV 10 can obtain the Doppler shift Δv from the frequency of a beat signal obtained from the interference between the received reflected light and predetermined reference light and can determine the frequency f of the target object 1 from the Doppler shift Δv.

FIG. 2 is a diagram illustrating a configuration example of the LDV 10.

The LDV 10 illustrated in FIG. 2 includes a laser light source 11, beam splitters 12, 13, and 16, a mirror 14, a frequency converter 15, an optical receiver 17, and an electrical signal processing unit 18.

The laser light source 11 emits laser light having a frequency v to the beam splitter 12.

The beam splitter 12 divides the laser light emitted from the laser light source 11 into two beams of light, emits one light into the beam splitter 13, and emits the other light into the frequency converter 15.

The beam splitter 13 transmits the emitted light of the beam splitter 12. The light transmitted through the beam splitter 13 is emitted from the LDV 10, and the target object 1 is irradiated with this light. In other words, the LDV 10 is installed so that the target object 1 is irradiated with the transmitted light of the beam splitter 13. The light with which the target object 1 is irradiated is reflected by the target object 1. The LDV 10 is installed so that the reflected light reflected by the target object 1 is incident to the beam splitter 13. The beam splitter 13 reflects the reflected light from the target object 1 and emits the reflected light to the mirror 14. As described above, the frequency of the reflected light is (v+Δv).

The mirror 14 reflects the emitted light (reflected light having a frequency of (v+Δv)) of the beam splitter 13 and emits the reflected light to the beam splitter 16.

The frequency converter 15 converts the frequency of the emitted light of the beam splitter 12 and emits light having a frequency of (v+v_{B}) to the beam splitter 16 as reference light.

The beam splitter 16 reflects the reference light having a frequency of (v+v_{B}), which is the emitted light of the frequency converter 15, and emits the reflected light to the optical receiver 17, transmits the reflected light having a frequency of (v+Δv), which is the emitted light of the mirror 14, and emits the transmitted light to the optical receiver 17.

The optical receiver 17 receives the emitted light of the beam splitter 16, converts the received light into an electrical signal by photoelectric conversion, and outputs the electrical signal to the electrical signal processing unit 18. The electrical signal obtained by photoelectrically converting the emitted light of the beam splitter 16 includes a beat signal having a frequency of (v_{B}+Δv) caused by the interference between the reference light and the reflected light.

The electrical signal processing unit 18 processes the electrical signal output from the optical receiver 17 and obtains the Doppler shift Δv. As described above, the electrical signal output from the optical receiver 17 includes a beat signal having a frequency of (v_{B}+Δv). The VB is known. Thus, the electrical signal processing unit 18 can obtain the Doppler shift Δv from the frequency of (v_{B}+Δv) of the beat signal and obtain the frequency f of the target object 1 from the Doppler shift Δv.

As illustrated in FIG. 3, a case in which, in a complex 3 including the target object 1 and a structure 2 to which the target object 1 is attached, the vibration of the target object 1 is measured using the above-described LDV 10 is considered.

The mass of the structure 2 is larger than the mass of the target object 1 and is hardly influenced by the vibration of the target object 1. On the other hand, the target object 1 is greatly influenced by the vibration derived from the structure 2. In other words, a Doppler shift Δvₐ in the reflected light reflected by the target object 1 is influenced by a frequency f₁ of the target object 1 and a frequency f₂ of the structure 2. Thus, in the measurement of the vibration by the irradiation of only the target object 1 with the laser light, the influence of the vibration of the structure 2 is included as noise in measurement data.

In order to remove the noise described above, there is a method in which one LDV 10 separately measures the vibration of the target object 1 attached to the structure 2 and the vibration of the structure 2 itself, and a difference between measurement data of the vibration of the target object 1 and measurement data of the vibration of the structure 2 itself is extracted. Unfortunately, in this method, two measurements are required to measure the vibration of each of the target object 1 and the structure 2, and thus setting of the LDV 10 takes time and effort. In addition, it is not possible to simultaneously measure the aspect of vibration against automobile passing adjacent to the structure 2 or an positive impact with a hammer or the like.

Thus, in order to simultaneously measure the vibration of each of the target object 1 and the structure 2, a method of installing two LDVs 10 (LDV 10a and LDV 10b) is considered as illustrated in FIG. 4. In this method, the LDV l0a irradiates the target object 1 with laser light, receives the reflected light, and obtains a Doppler shift Δvₐ of the reflected light. The LDV 10b irradiates the structure 2 with laser light, receives the reflected light, and obtains a Doppler shift Δv_{b} of the reflected light. Unfortunately, in this method, an electrical signal processing apparatus 20 for comparing pieces of measurement data of the two LDVs 10 and obtaining the frequency of the target object 1 from the Doppler shift Δvₐ and the Doppler shift Δv_{b} is further required. In addition, in this method, in an outdoor environment, it may be difficult to install the two LDVs 10 under the same conditions due to space or scaffolding restrictions. In addition, in this method, the own vibrations of the two LDVs 10 are separately included in the measurement data. Thus, signal processing of the measurement data becomes difficult.

Considering the problems described above, an object of the present disclosure is to provide a measurement apparatus and a measurement method capable of more simply evaluating vibration of a target object with higher accuracy.

### Means for Solving the Problem

According to an embodiment, a measurement apparatus includes a laser light source, a beam splitter configured to branch laser light emitted from the laser light source into first branch light and second branch light and irradiate a first target object with the first branch light, an optical path converter configured to convert a direction of the second branch light to a direction in which a second target object is irradiated with the second branch light, and irradiate the second target object with the second branch light, and a light reception unit configured to receive first reflected light obtained in a manner that the first branch light is reflected by the first target object and second reflected light obtained in a manner that the second branch light is reflected by the second target object.

According to the embodiment, there is provided a measurement method in a measurement apparatus including a laser light source and a light reception unit. The measurement method includes branching laser light emitted from the laser light source into first branch light and second branch light and irradiating a first target object with the first branch light, converting a direction of the second branch light to a direction in which a second target object is irradiated with the second branch light, and irradiating the second target object with the second branch light, and receiving, by the light reception unit, first reflected light and second reflected light, the first reflected light being obtained in a manner that the first branch light is reflected by the first target object, and the second reflected light being obtained in a manner that the second branch light is reflected by the second target object.

### Effects of the Invention

According to the measurement apparatus and the measurement method according to the present disclosure, it is possible to more simply evaluate vibration of a target object with higher accuracy.

### BRIEF DESCRIPTION OF DRAWINGS

FIG. 1 is a diagram illustrating measurement of vibration of a target object with an LDV in the related art.

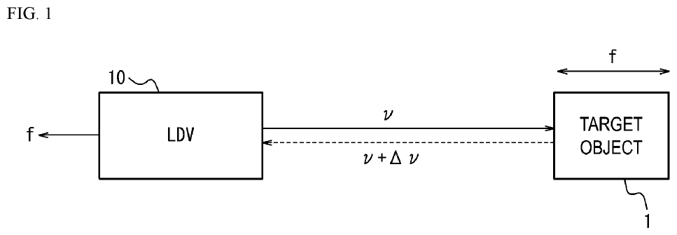

FIG. 2 is a diagram illustrating a configuration example of the LDV illustrated in FIG. 1.

FIG. 3 is a diagram illustrating an example of measuring vibration of a target object attached to a structure with the LDV in the related art.

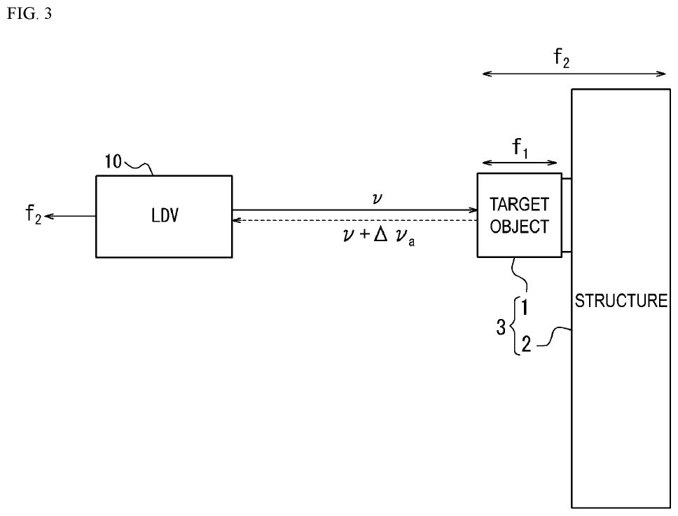

FIG. 4 is a diagram illustrating another example of measuring the vibration of the target object attached to the structure with the LDV in the related art.

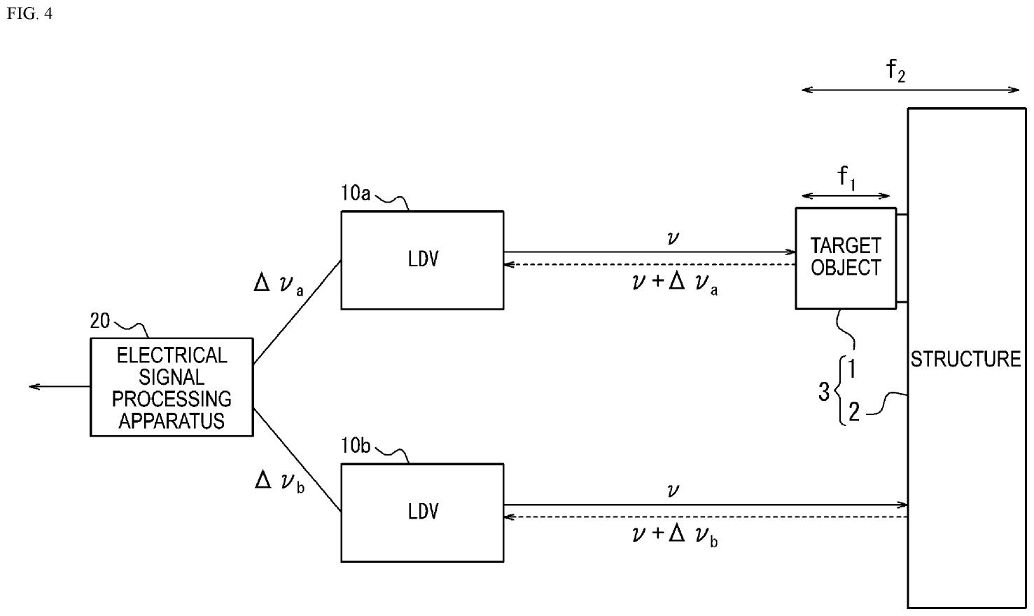

FIG. 5 is a diagram illustrating a main configuration of a measurement apparatus according to a first embodiment of the present disclosure.

FIG. 6 is a diagram illustrating a configuration example of the measurement apparatus illustrated in FIG. 5.

FIG. 7 is a flowchart illustrating an example of an operation of the measurement apparatus illustrated in FIG. 5.

FIG. 8 is a diagram illustrating a configuration example of a measurement apparatus according to a second embodiment of the present disclosure.

FIG. 9 is a diagram illustrating a configuration example of a measurement apparatus according to a third embodiment of the present disclosure.

FIG. 10 is a diagram illustrating a configuration example of a measurement apparatus according to a fourth embodiment of the present disclosure.

FIG. 11 is a diagram illustrating a configuration example of a measurement apparatus according to a fifth embodiment of the present disclosure.

FIG. 12 is a diagram illustrating a configuration example of a measurement apparatus according to a sixth embodiment of the present disclosure.

FIG. 13 is a diagram illustrating a configuration example of a measurement apparatus according to a seventh embodiment of the present disclosure.

FIG. 14 is a diagram illustrating an example of an appearance of a measurement apparatus according to the present disclosure.

FIG. 15 is a diagram illustrating an example of an installation state of the measurement apparatus illustrated in FIG. 14.

### DESCRIPTION OF EMBODIMENTS

Hereinafter, embodiments for carrying out the present disclosure will be described with reference to the drawings.

### First Embodiment

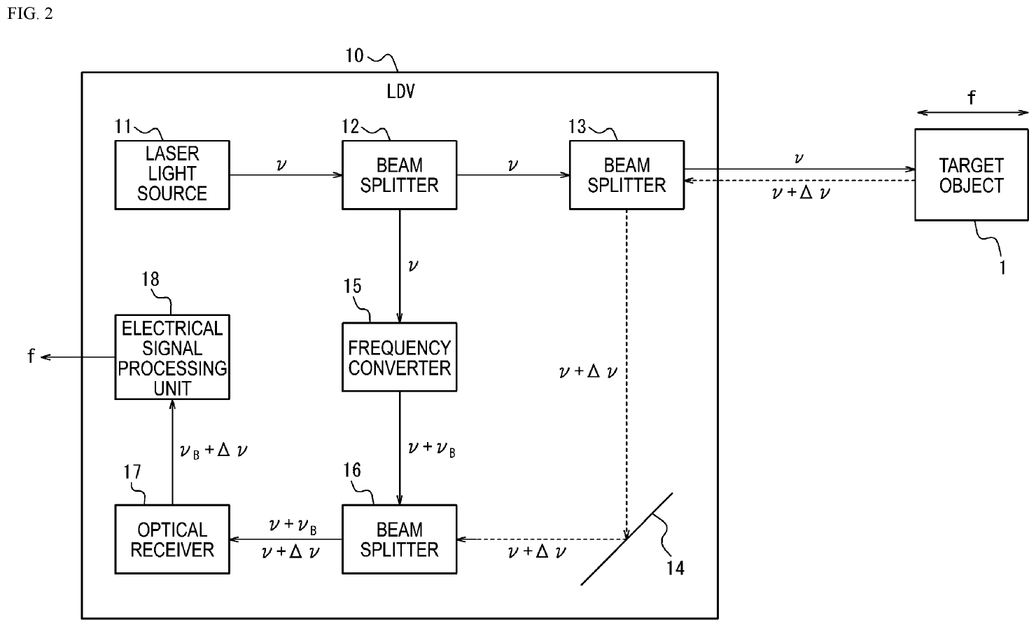

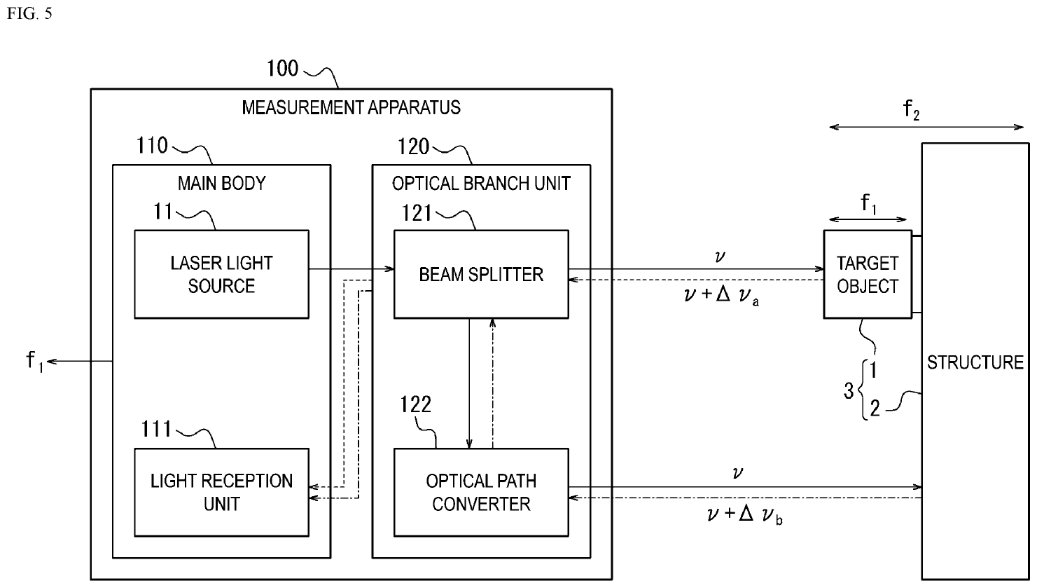

FIG. 5 is a diagram illustrating a main configuration of a measurement apparatus 100 according to a first embodiment of the present disclosure. The measurement apparatus 100 according to the present embodiment measures the vibration of a target object 1 in a complex 3 in which the target object 1 is attached to a structure 2. More specifically, the measurement apparatus 100 according to the present embodiment is a laser Doppler vibrometer that irradiates the target object 1 with laser light, receives reflected light obtained in a manner that the light used in the irradiation is reflected by the target object 1, and evaluates the vibration of the target object 1 based on a change in the frequency of the reflected light. In FIG. 5, the similar components to those in FIG. 2 are denoted by the same reference signs, and description thereof will not be repeated.

The measurement apparatus 100 illustrated in FIG. 5 includes a main body 110 and an optical branch unit 120.

The main body 110 includes a laser light source 11 and a light reception unit 111. The optical branch unit 120 includes a beam splitter 121 and an optical path converter 122.

The laser light source 11 emits laser light having a frequency v to the beam splitter 121.

The beam splitter 121 divides the emitted light of the laser light source 11 into two beams of light. One light (hereinafter referred to as “first branch light”) of the two beams of laser light obtained by division of the beam splitter 121 is emitted from the measurement apparatus 100, and the target object 1 (first target object) is irradiated with the first branch light. The other light (hereinafter referred to as “second branch light”) of the two beams of laser light obtained by division of the beam splitter 121 is emitted to the optical path converter 122. That is, the beam splitter 121 divides the light emitted from the laser light source 11 into two beams of light, causes the first branch light to be emitted from the measurement apparatus 100, and emits the second branch light to the optical path converter 122.

The optical path converter 122 converts a direction of the second branch light to a direction in which the structure 2 to which the target object 1 is attached is irradiated with the second branch light, which is the emitted light of the beam splitter 121. The second branch light whose direction is converted by the optical path converter 122 is emitted from the measurement apparatus 100, and the structure 2 is irradiated with the emitted second branch light. In other words, the optical path converter 122 converts the direction of the second branch light to a direction in which the structure 2 (second target object) is irradiated with the second branch light and irradiates the structure 2 with the second branch light. The second branch light is emitted from the measurement apparatus 100 parallel to the first branch light, for example.

The light with which the target object 1 is irradiated is reflected by the target object 1. The light with which the structure 2 is irradiated is reflected by the structure 2. In the following drawings, reflected light (referred to as “first reflected light” below) reflected by the target object 1 is indicated by a broken line, and reflected light (hereinafter referred to as “second reflected light”) reflected by the structure 2 is indicated by a one-dot chain line.

A frequency of the first reflected light is shifted from a frequency v of the emitted light of the laser light source 11 by a Doppler shift Δvₐ caused by a frequency f₁ of the target object 1 and a frequency f₂ of the structure 2. The Doppler shift Δvₐ is a shift amount that includes a plurality of FM modulation components and changes in time. The frequency of the first reflected light is (v+Δvₐ). A frequency of the second reflected light is shifted from the frequency v of the emitted light of the laser light source 11 by a Doppler shift Δv_{b} mainly caused by the frequency f₂ of the structure 2. The Doppler shift Δv_{b} is a shift amount that changes in time by FM modulation of the frequency f₂ of the structure 2, and the influence of the frequency f₁ of the target object 1 can be ignored. The frequency of the second reflected light is (v+Δv_{b}).

The first reflected light and the second reflected light are incident on the main body 110 through the optical branch unit 120. For example, the first reflected light is transmitted through the beam splitter 121 and then is incident to the main body 110. The second reflected light is reflected by the optical path converter 122 and the beam splitter 121 in this order, and then is incident to the main body 110.

The light reception unit 111 receives the first reflected light and the second reflected light. As will be described in detail below, the light reception unit 111 outputs electrical signals obtained by photoelectrically converting the first reflected light, the second reflected light, and predetermined reference light. The frequency f₁ of the target object 1 can be obtained from the electrical signal output from the light reception unit 111.

As described above, in the measurement apparatus 100 according to the present embodiment, the light emitted from the laser light source 11 is branched into the first branch light and the second branch light, the target object 1 is irradiated with the first branch light, and the structure 2 is irradiated with the second branch light. In the measurement apparatus 100 according to the present embodiment, the light reception unit 111 receives the first reflected light obtained in a manner that the first branch light is reflected by the target object 1, and the second reflected light obtained in a manner that the second branch light is reflected by the structure 2. Thus, in one measurement by one measurement apparatus 100, it is possible to simultaneously measure the frequency f₁ of the target object 1 and the frequency f₂ of the structure 2. Thus, it is possible to more simply evaluate the vibration of the target object 1 with higher accuracy.

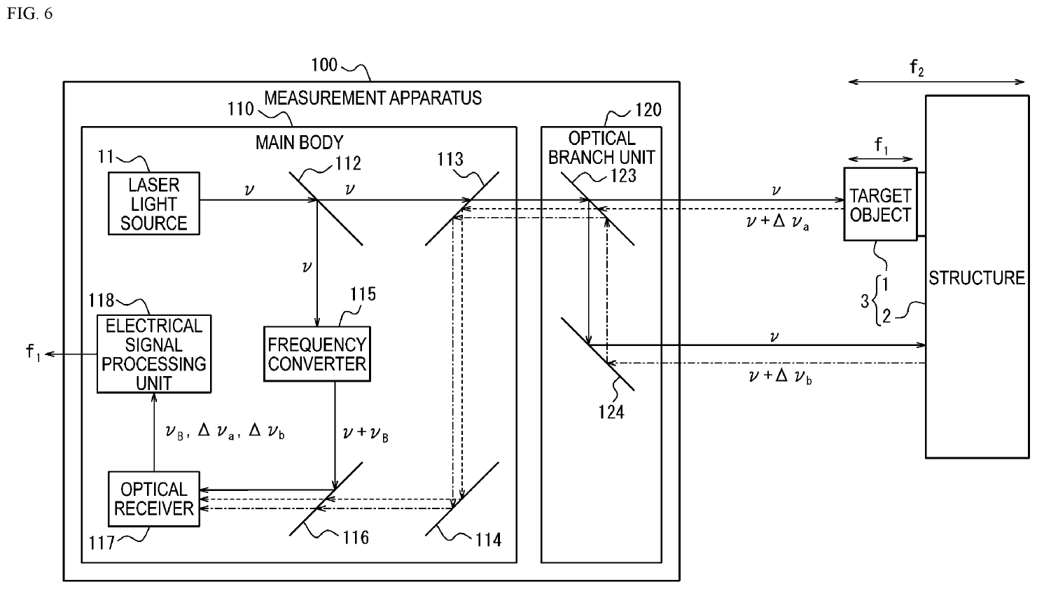

FIG. 6 is a diagram illustrating a configuration example of the measurement apparatus 100 according to the present embodiment. In FIG. 6, the similar components to those in FIG. 5 are denoted by the same reference signs, and description thereof will not be repeated.

The measurement apparatus 100 illustrated in FIG. 6 includes the laser light source 11, half mirrors 112, 113, 116, and 123, a mirror 114, a frequency converter 115, an optical receiver 117, an electrical signal processing unit 118, and a total reflection mirror 124. The optical receiver 117 is an example of the light reception unit 111. The half mirror 123 is an example of the beam splitter 121. The total reflection mirror 124 is an example of the optical path converter 122. The laser light source 11, the half mirrors 112, 113, and 116, the mirror 114, the frequency converter 115, the optical receiver 117, and the electrical signal processing unit 118 are housed in the main body 110. The half mirror 123 and the total reflection mirror 124 are housed in the optical branch unit 120.

The half mirror 112 divides the emitted light of the laser light source 11 into two beams of light, emits one light to the half mirror 113, and emits the other light to the frequency converter 115.

The half mirror 113 transmits the emitted light of the half mirror 112 and emits the emitted light to the half mirror 123.

The half mirror 123 divides the emitted light of the half mirror 113 into two beams of light, which are the first branch light and the second branch light. The half mirror 123 transmits the first branch light, reflects the second branch light, and emits the first branch light and the second branch light to the total reflection mirror 124. The first branch light transmitted through the half mirror 123 is emitted from the measurement apparatus 100, and the target object 1 is irradiated with the emitted first branch light. In other words, the measurement apparatus 100 is installed so that the target object 1 is irradiated with the first branch light transmitted through the half mirror 123. As described above, the half mirror 123 as the beam splitter 121 branches light emitted from the laser light source 11 into the first branch light and the second branch light and irradiates the target object (first target object) 1 with the first branch light.

The light with which the target object 1 is irradiated is reflected by the target object 1. The measurement apparatus 100 is installed so that the first reflected light reflected by the target object 1 is incident to the half mirror 123. The half mirror 123 transmits the first reflected light and emits the first reflected light to the half mirror 113. As described above, the frequency of the first reflected light is (v+Δvₐ). The half mirror 123 reflects the second reflected light emitted from the total reflection mirror 124, which will be described below, and emits the second reflected light to the half mirror 113.

The total reflection mirror 124 converts the direction of the second branch light to a direction in which the structure (second target object) 2 to which the target object 1 is attached is irradiated with the second branch light emitted from the half mirror 123, and then emits the second branch light. The second branch light emitted from the total reflection mirror 124 is emitted from the measurement apparatus 100, and the structure 2 is irradiated with the second branch light.

The light with which the structure 2 is irradiated is reflected by the structure 2. The measurement apparatus 100 is installed so that the second reflected light reflected by the structure 2 is incident to the total reflection mirror 124. The total reflection mirror 124 reflects the second reflected light and emits the second reflected light to the half mirror 123. As described above, the frequency of the second reflected light is (v+Δv_{b}).

The half mirror 113 reflects the first reflected light transmitted through the half mirror 123 and the second reflected light reflected by the half mirror 123 and emits the first reflected light and the second reflected light to the mirror 114.

The mirror 114 reflects the first reflected light and the second reflected light emitted from the half mirror 113 and emits the first reflected light and the second reflected light to the half mirror 116.

The frequency converter 115 converts the frequency of the emitted light of the half mirror 112 and emits light having a frequency of (v+v_{B}) to the half mirror 116 as the reference light.

The half mirror 116 reflects the reference light emitted from the frequency converter 115 and emits the reference light to the optical receiver 117, and transmits the first reflected light and the second reflected light emitted from the mirror 114 and emits the first reflected light and the second reflected light to the optical receiver 117.

The optical receiver 117 receives the reference light, the first reflected light, and the second reflected light emitted from the half mirror 116, converts the received light into an electrical signal by photoelectric conversion, and outputs the electrical signal to the electrical signal processing unit 118. The electrical signal obtained by photoelectrically converting the emitted light of the half mirror 116 includes a beat signal having a frequency of (v_{B}+Δvₐ) caused by interference between the reference light and the first reflected light, and a beat signal having a frequency of (v_{B}+Δv_{b}) caused by interference between the reference light and the second reflected light.

The electrical signal processing unit 118 processes the electrical signal output from the optical receiver 117 and obtains Doppler shifts Δvₐ and Δv_{b}. v_{B} is known. Thus, the electrical signal processing unit 118 obtains the Doppler shift Δvₐ based on the beat signal having a frequency of (v_{B}+Δvₐ) and obtains the Doppler shift Δv_{b} based on the beat signal having a frequency of (v_{B}+Δv_{b}). It is possible to obtain the frequency f₁ of the target object 1 and the frequency f₂ of the structure 2 from the Doppler shifts Δvₐ and Δv_{b}. It is possible to evaluate the vibration of the target object 1 by removing an influence of the frequency f₂ from the frequency f₁. For example, the electrical signal processing unit 118 performs fast Fourier transform on the electrical signal output from the optical receiver 117 and detects components of the frequency f₁ inherent to the target object 1 and the frequency f₂ of the structure 2. The electrical signal processing unit 118 can obtain the frequency f₁ inherent to the target object 1 by removing the frequency around the theoretically estimated frequency f₂ with a filter.

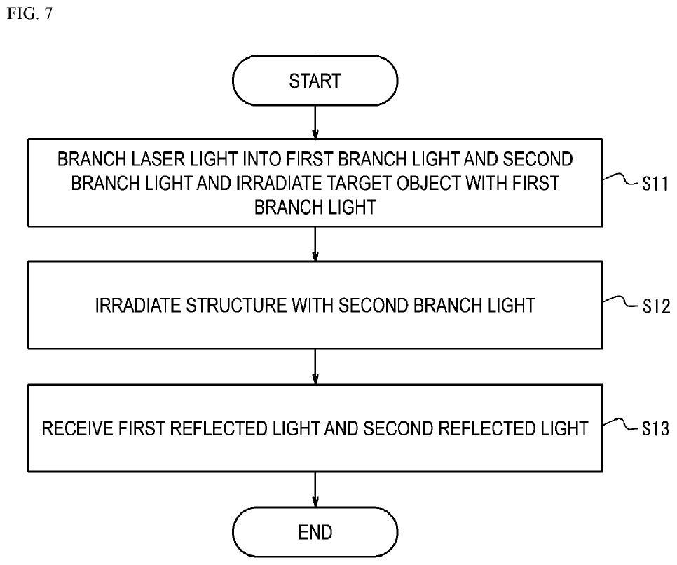

FIG. 7 is a flowchart illustrating an example of an operation of the measurement apparatus 100 according to the present embodiment illustrated in FIG. 5, and is a diagram illustrating a measurement method in the measurement apparatus 100.

The beam splitter 121 branches laser light emitted from the laser light source 11 into first branch light and second branch light and irradiates a target object 1 with the first branch light (Step S11). The beam splitter 121 emits the second branch light to the optical path converter 122.

The optical path converter 122 converts the direction of the second branch light so that the structure 2 is irradiated with the second branch light emitted from the beam splitter 121 (Step S12).

The first branch light with which the target object 1 is irradiated is reflected by the target object 1. The second branch light with which the structure 2 is irradiated is reflected by the structure 2.

The light reception unit 111 receives first reflected light obtained in a manner that the first branch light is reflected by the target object 1, and second reflected light obtained in a manner that the second branch light is reflected by the structure 2 (Step S13).

As described above, in the present embodiment, the measurement apparatus 100 includes the laser light source 11, the beam splitter 121, the optical path converter 122, and the light reception unit 111. The beam splitter 121 branches laser light emitted from the laser light source 11 into first branch light and second branch light and irradiates a target object 1 with the first branch light. The optical path converter 122 converts the direction of the second branch light to a direction in which the structure 2 is irradiated with the second branch light and irradiates the structure 2 with the second branch light. The light reception unit 111 receives the first reflected light obtained in a manner that the first branch light is reflected by the target object 1, and the second reflected light obtained in a manner that the second branch light is reflected by the structure 2.

Thus, in one measurement apparatus 100, the target object 1 and the structure 2 are simultaneously irradiated with light, and thus the frequency f₁ of the target object 1 and the frequency f₂ of the structure 2 may be simultaneously measured. Thus, the vibration of the target object 1 may be more simply evaluated with higher accuracy.

In the present embodiment, the optical system of the main body 110 has a heterodyne configuration illustrated in FIG. 6, but the optical system is not limited thereto. The optical system can have any configuration so long as the optical system can receive the first reflected light and the second reflected light. In the present embodiment, an example in which the target object 1 is irradiated with the first branch light, and the structure 2 is irradiated with the second branch light has been described, but the present embodiment is not limited thereto. The structure 2 may be irradiated with the first branch light, and the target object 1 may be irradiated with the second branch light.

### Second Embodiment

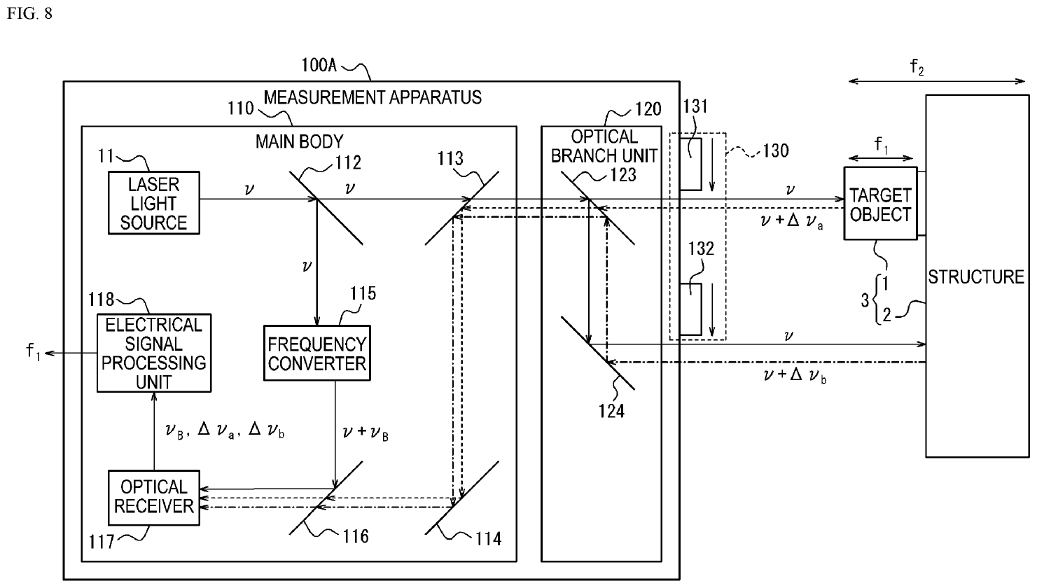

FIG. 8 is a diagram illustrating a configuration example of a measurement apparatus 100A according to a second embodiment of the present disclosure.

The measurement apparatus 100A according to the present embodiment is different from the measurement apparatus 100 illustrated in FIG. 6 in that shutters 131 and 132 are added. The shutters 131 and 132 are an example of a selection unit 130 capable of individually selecting the incidence of the first reflected light and the second reflected light to the light reception unit 111.

The shutter 131 is capable of shielding the first branch light. The shutter 131 is capable of performing switching between opening and closing. In an open state, the shutter 131 causes the first branch light to be emitted from the measurement apparatus 100A. In a closed state, the shutter 131 shields the first branch light. The first branch light is shielded so that the first reflected light is not incident to the light reception unit 111.

The shutter 132 is capable of shielding the second branch light. The shutter 132 is capable of performing switching between opening and closing. In an open state, the shutter 132 causes the second branch light to be emitted from the measurement apparatus 100A. In a closed state, the shutter 132 shields the second branch light. The second branch light is shielded so that the second reflected light is not incident to the light reception unit 111.

The shutter 131 and the shutter 132 can individually perform switching between the open state and the closed state. Thus, according to the shutters 131 and 132, the incidence of the first reflected light and the second reflected light to the light reception unit 111 can be individually selected.

By enabling individual selection of the incident of the first reflected light and the second reflected light to the light reception unit 111, the light reception unit 111 can individually receive the reflected light from the target object 1 and the structure 2. Thus, the measurement apparatus 100A according to the present embodiment can be used as a vibrometer having a function similar to the function of the LDV 10 in the related art.

In the present embodiment, an example in which the selection unit 130 is the shutters 131 and 132 capable of shielding the first branch light and the second branch light has been described, but the present embodiment is not limited thereto. The selection unit 130 may have any configuration so long as the selection unit 130 can individually select the incident of the first reflected light and the second reflected light to the light reception unit 111. For example, the selection unit 130 may be configured to selectively absorb the first branch light and the second branch light. The selection unit 130 may be configured to selectively absorb the first reflected light and the second reflected light. The selection unit 130 may be configured to perform selective switching between the optical paths of the first reflected light and the second reflected light so that the first reflected light and the second reflected light are not incident to the light reception unit 111.

### Third Embodiment

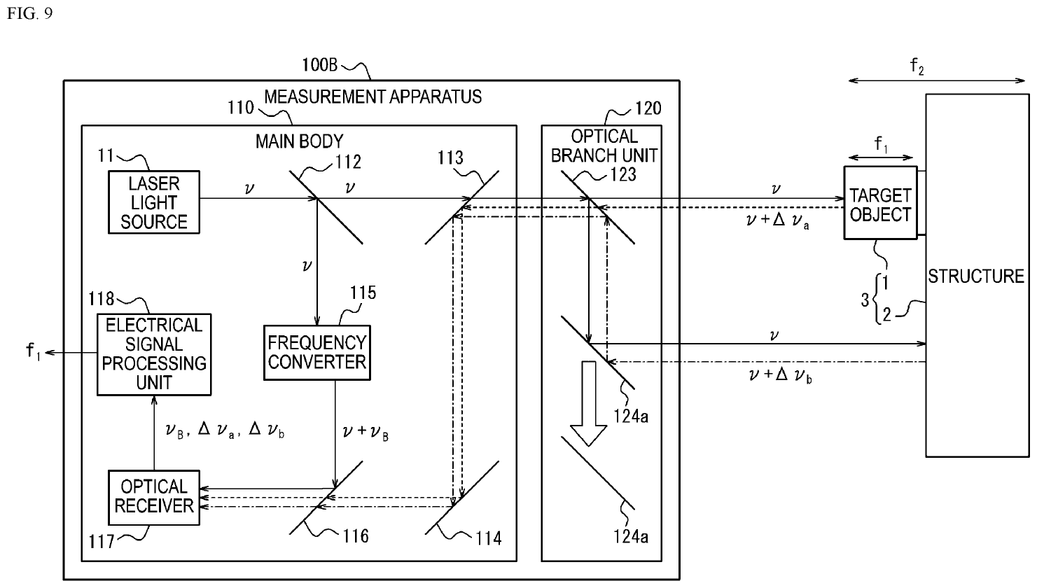

FIG. 9 is a diagram illustrating a configuration example of a measurement apparatus 100B according to a third embodiment of the present disclosure.

The measurement apparatus 100B according to the present embodiment is different from the measurement apparatus 100 illustrated in FIG. 6 in that the total reflection mirror 124 is changed to a total reflection mirror 124a.

The total reflection mirror 124a is provided to be capable of adjusting the irradiation position of the second branch light. For example, the total reflection mirror 124a is provided so as to be movable along an optical path direction of the second branch light emitted from the half mirror 123. By the total reflection mirror 124a moving along the optical path direction of the second branch light, the irradiation position of the second branch light also moves along the optical path direction of the second branch light.

When the irradiation position of the first branch light and the irradiation position of the second branch light are fixed, it may be difficult to simultaneously irradiate the target object 1 and the structure 2 with light, depending on the form or the size of the target object 1 attached to the structure 2. By enabling adjustment of the irradiation position of the second branch light as in the measurement apparatus 100B according to the present embodiment, it is easy to simultaneously irradiate the target object 1 and the structure 2 with light.

### Fourth Embodiment

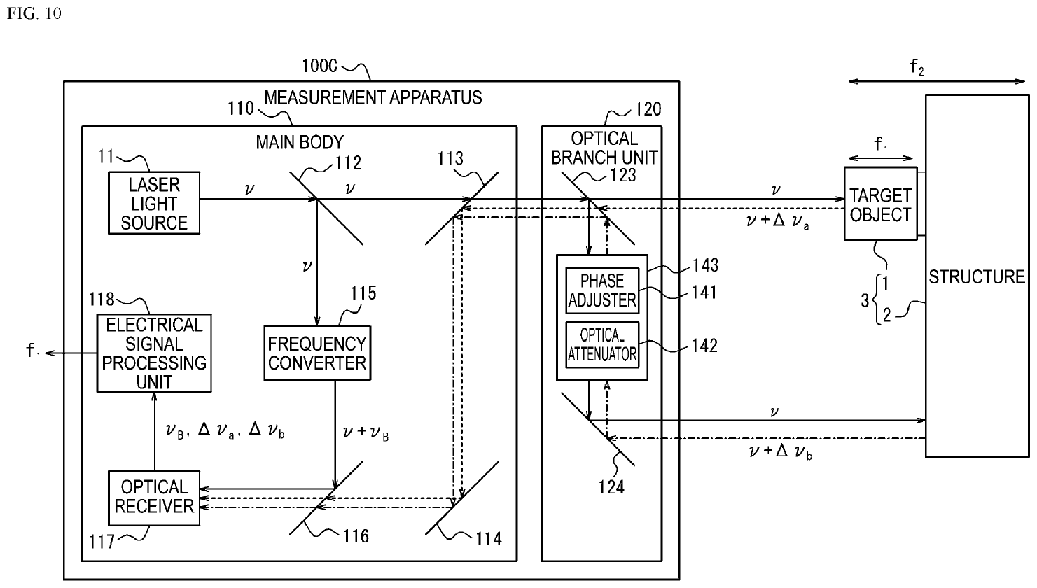

FIG. 10 is a diagram illustrating a configuration example of a measurement apparatus 100C according to a fourth embodiment of the present disclosure.

The measurement apparatus 100C according to the present embodiment is different from the measurement apparatus 100 illustrated in FIG. 6 in that the measurement apparatus 100C includes a phase adjuster 141 and an optical attenuator 142. The phase adjuster 141 and the optical attenuator 142 constitute an adjustment unit 143.

The phase adjuster 141 is provided between the half mirror 123 as the beam splitter 121 and the total reflection mirror 124 as the optical path converter 122. The phase adjuster 141 is capable of adjusting the phases (that is, optical path lengths) of the second branch light and the second reflected light.

The optical attenuator 142 is provided between the half mirror 123 as the beam splitter 121 and the total reflection mirror 124 as the optical path converter 122. The optical attenuator 142 is capable of adjusting the amplitudes of the second branch light and the second reflected light.

As described above, the phase adjuster 141 and the optical attenuator 142 constitute the adjustment unit 143. Thus, the adjustment unit 143 is provided between the beam splitter 121 and the optical path converter 122 and is capable of adjusting at least one of the phase and the amplitude of light propagating (second branch light and second reflected light) between the beam splitter 121 and the optical path converter 122.

By adjusting the phase or the amplitude of the light propagating between the beam splitter 121 and the optical path converter 122, the measurement apparatus 100C can cause the first reflected light and the second reflected light to interfere with each other to optically remove the vibration component inherent to the structure 2, and to visualize the change in the frequency spectrum.

### Fifth Embodiment

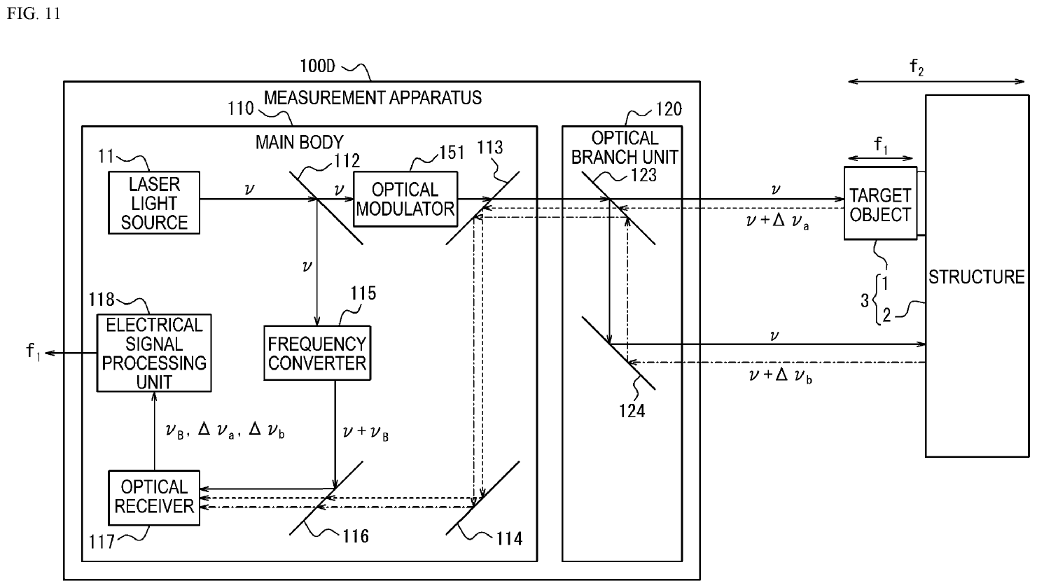

FIG. 11 is a diagram illustrating a configuration example of a measurement apparatus 100D according to a fifth embodiment of the present disclosure.

The measurement apparatus 100D according to the present embodiment is different from the measurement apparatus 100 illustrated in FIG. 6 in that an optical modulator 151 is added.

The optical modulator 151 is provided between the laser light source 11 and the half mirror 123 as the beam splitter 121. The optical modulator 151 is capable of modulating the emitted light of the laser light source 11.

In the present embodiment, the laser light source 11 emits pulsed light, for example. Because the optical modulator 151 modulates the pulsed light emitted from the laser light source 11, a difference between an optical path (between the half mirror 123 and the target object 1) and an optical path (between the total reflection mirror 124 and the structure 2) appears as a time difference between time when the optical receiver 117 receives the first reflected light and time when the optical receiver receives the second reflected light. Thus, the electrical signal processing unit 118 can separate a signal component caused by the reflected light (first reflected light) from the target object 1 and a signal component from the reflected light (second reflected light) from the structure 2. As a result, according to the measurement apparatus 100D according to the present embodiment, similar to the measurement apparatus 100A illustrated in FIG. 8, it is possible to individually measure the reflected light from the target object 1 and the reflected light from the structure 2.

### Sixth Embodiment

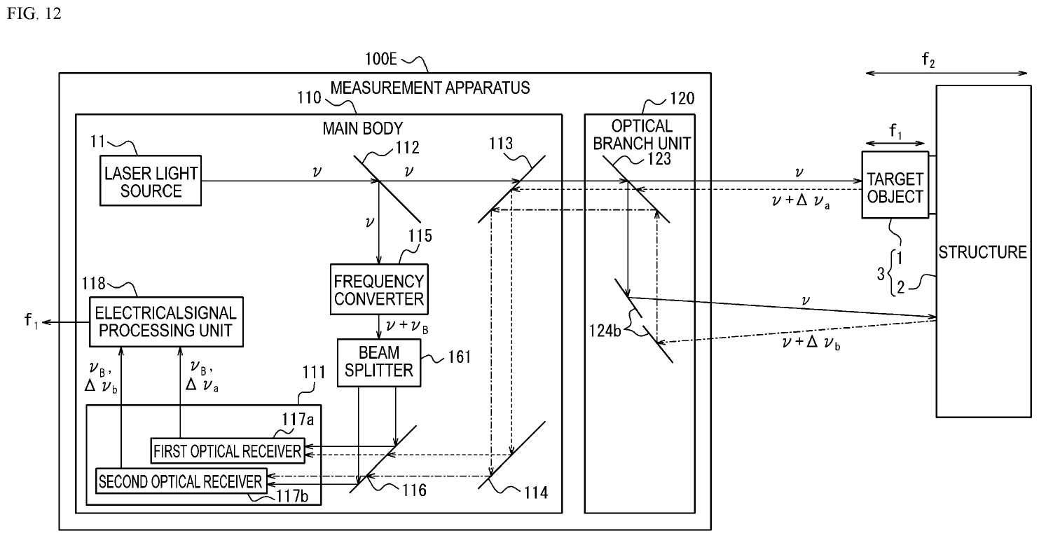

FIG. 12 is a diagram illustrating a configuration example of a measurement apparatus 100E according to a sixth embodiment of the present disclosure.

The measurement apparatus 100E according to the present embodiment is different from the measurement apparatus 100 illustrated in FIG. 6 in that the total reflection mirror 124 is changed to a total reflection mirror 124b, a beam splitter 161 is added, the optical receiver 117 is removed, and a first optical receiver 117a and a second optical receiver 117b are added. The first optical receiver 117a and the second optical receiver 117b constitute the light reception unit 111.

The total reflection mirror 124b is configured by combining two mirrors, for example. The total reflection mirror 124b reflects the second reflected light and emits the second reflected light to the half mirror 123 so that an optical axis of the first reflected light is not parallel to an optical axis of the second reflected light. Because the optical axis of the first reflected light is not parallel to the optical axis of the second reflected light, the optical axis of the first reflected light and the optical axis of the second reflected light are shifted from each other in the main body 110, as illustrated in FIG. 12. Thus, the optical axis of the first reflected light incident to the light reception unit 111 and the optical axis of the second reflected light incident to the light reception unit 111 are shifted from each other. Thus, the total reflection mirror 124b functions as an optical system that shifts the optical axis of the first reflected light incident to the light reception unit 111 and the optical axis of the second reflected light incident to the light reception unit 111 from each other.

The beam splitter 161 divides the reference light having a frequency (v+v_{B}) emitted from the frequency converter 115 into two beams of light and emits one light (referred to as “first reference light” below) and the other light (hereinafter referred to as “second reference light”) into the half mirror 116.

The half mirror 116 transmits the first reflected light emitted from the mirror 114, emits the first reflected light to the first optical receiver 117a, reflects the first reference light emitted from the beam splitter 161, and emits the first reference light to the first optical receiver 117a. The half mirror 116 transmits the second reflected light emitted from the mirror 114, emits the second reflected light to the second optical receiver 117b, reflects the second reference light emitted from the beam splitter 161, and emits the second reference light to the second optical receiver 117b. As described above, in the main body 110, the optical axis of the first reflected light and the optical axis of the second reflected light are shifted from each other. Thus, the half mirror 116 can cause the first reflected light and the second reflected light to be separately incident to the light reception unit 111.

The first optical receiver 117a receives the first reflected light and the first reference light emitted from the half mirror 116, converts the received light into an electrical signal by photoelectric conversion, and outputs the electrical signal to the electrical signal processing unit 118. The electrical signal output from the first optical receiver 117a includes a beat signal having a frequency of (v_{B}+Δvₐ) caused by interference between the first reference light and the first reflected light.

The second optical receiver 117b receives the second reflected light and the second reference light emitted from the half mirror 116, converts the received light into an electrical signal by photoelectric conversion, and outputs the electrical signal to the electrical signal processing unit 118. The electrical signal output from the second optical receiver 117b includes a beat signal having a frequency of (v_{B}+Δv_{b}) caused by interference between the second reference light and the second reflected light.

In the first to fifth embodiments described above, after the reflection by the half mirror 123, the first reflected light and the second reflected light propagate along the same optical axis and are received by one optical receiver 117. In the present embodiment, by shifting the optical axis of the first reflected light and the optical axis of the second reflected light from each other, it is possible to cause the first reflected light and the second reflected light to be separately incident to the light reception unit 111. Thus, the first reflected light and the second reflected light can be received by the separate optical receivers 117 (the first optical receiver 117a and the second optical receiver 117b), respectively. By the first optical receiver 117a and the second optical receiver 117b receiving the first reflected light and the second reflected light, it is possible to individually process an electrical signal output from each of the first optical receiver 117a and the second optical receiver 117b, and to individually evaluate the vibration of the target object 1 and the vibration of the structure 2.

In the present embodiment, an example in which the total reflection mirror 124b is used as an example of an optical system that shifts the optical axis of the first reflected light and the optical axis of the second reflected light from each other has been described, but the present embodiment is not limited thereto. The optical system that shifts the optical axis of the first reflected light and the optical axis of the second reflected light from each other may have any configuration so long as the optical system can cause the optical axis of the first reflected light and the optical axis of the second reflected light to be separately incident to the light reception unit 111.

### Seventh Embodiment

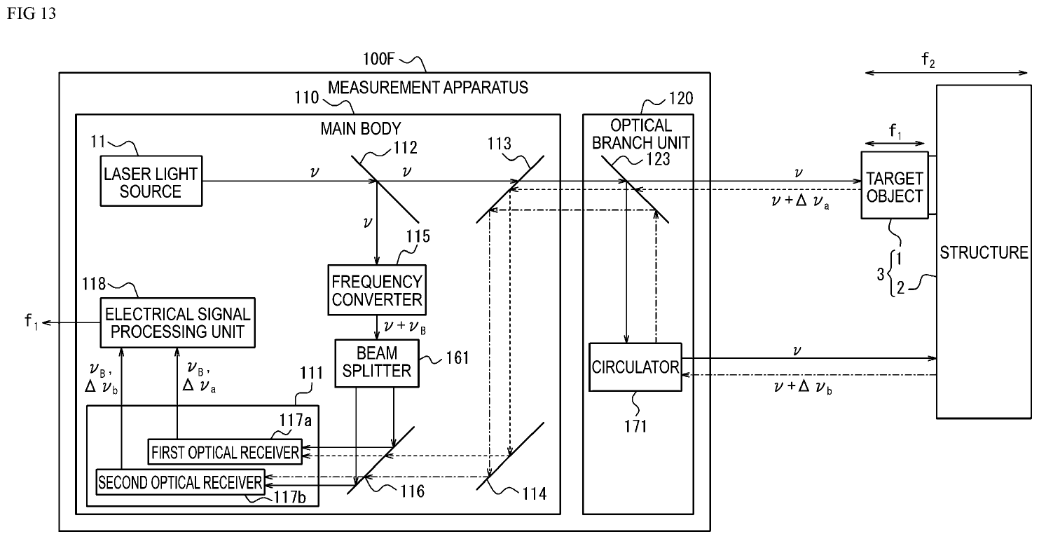

FIG. 13 is a diagram illustrating a configuration example of a measurement apparatus 100F according to a seventh embodiment of the present disclosure.

The measurement apparatus 100F according to the present embodiment is different from the measurement apparatus 100E illustrated in FIG. 12 in that the total reflection mirror 124b is changed to a circulator 171.

The circulator 171 is an optical element formed by combining a plurality of prisms. The circulator 171 emits the second branch light such that the optical axis of the second branch light emitted from the measurement apparatus 100F is parallel with the optical axis of the first branch light emitted from the measurement apparatus 100F. The circulator 171 shifts the optical axis of the second reflected light obtained in a manner that the second branch light is reflected by the structure 2 and emits the second reflected light to the half mirror 123. By shifting the optical axis of the second reflected light and emitting the second reflected light to the half mirror 123, as illustrated in FIG. 13, the optical axis of the first reflected light and the optical axis of the second reflected light are shifted from each other in the main body 110. Thus, the optical axis of the first reflected light incident to the light reception unit 111 and the optical axis of the second reflected light incident to the light reception unit 111 are shifted from each other. Thus, the circulator 171 functions as an optical system that shifts the optical axis of the first reflected light incident to the light reception unit 111 and the optical axis of the second reflected light incident to the light reception unit 111 from each other.

In the measurement apparatus 100E illustrated in FIG. 12, when the target object 1 is perpendicularly irradiated with the first branch light, the structure 2 is diagonally irradiated with the second branch light. Thus, measurement errors easily occur. In the present embodiment, the first branch light and the second branch light are emitted in parallel, and the target object 1 and the structure 2 are irradiated with the first branch light and the second branch light. Thus, it is possible to suppress the occurrence of the measurement errors caused by diagonal irradiation.

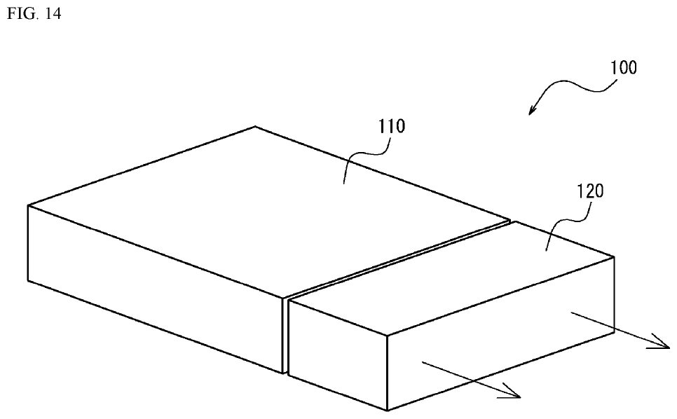

FIG. 14 is a diagram illustrating the appearance of the measurement apparatus 100 among the measurement apparatuses 100 to 100F according to the embodiments described above. As illustrated in FIG. 14, the measurement apparatus 100 includes the main body 110 that houses the laser light source 11 and the light reception unit 111, and the optical branch unit 120 that houses the beam splitter 121 and the optical path converter 122.

The optical branch unit 120 may be provided to be rotatable about the optical axis of the emitted light (first branch light or second branch light emitted from the measurement apparatus 100) of the measurement apparatus 100 with respect to the main body 110.

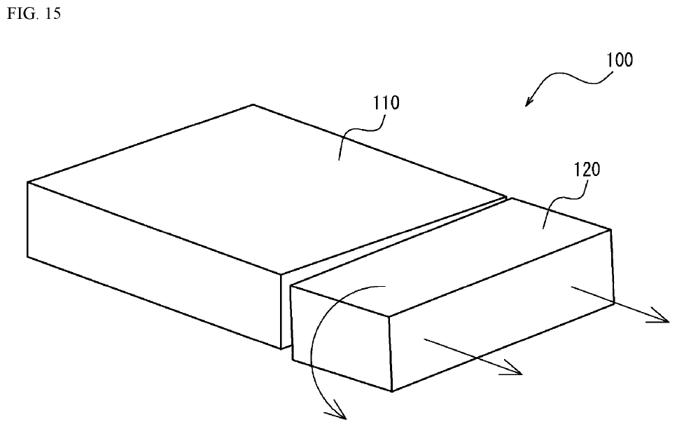

Depending on the installation location of the measurement apparatus 100, it may not be possible to install the measurement apparatus 100 horizontally. In this case, as illustrated in FIG. 15, by rotating the optical branch unit 120 about the optical axis of the emitted light of the measurement apparatus 100 with respect to the main body 110, it is possible to emit the first branch light and the second branch light parallel to the horizontal plane. In this manner, the vibration of the target object 1 can be evaluated more accurately.

In FIGS. 14 and 15, the measurement apparatus 100 has been described as an example, but the present invention is not limited thereto. In the measurement apparatuses 100A to 100F, the optical branch unit 120 may be provided to be rotatable about the optical axis of the emitted light of the measurement apparatuses 100A to 100F with respect to the main body 110.

In the embodiments described above, an example in which the half mirror is used as the beam splitter has been described, but the present invention is not limited thereto. Any element can be used so long as the element has an optical branching function. For example, a beam splitter obtained by combining prisms, a fiber type beam splitter, and a beam splitter configured by combining a planar waveguide (for example, a planar waveguide made of glass or polymer) and a lens system may be used.

In the embodiments described above, an example in which the total reflection mirrors 124, 124a, and 124b and the mirror 114 are used to convert the direction of the light has been described, but the present invention is not limited thereto. Any element can be used so long as the element has a function of converting the optical path. For example, a prism or the like can be used. In addition, regarding the type of mirror, any mirror having a function of converting the optical path, such as a whole vapor deposition mirror, a mirror metal mirror, and a dielectric multilayer film mirror, can be used.

Although the above embodiments have been described as representative examples, it will be apparent to those skilled in the art that many modifications and substitutions are possible within the spirit and scope of the present disclosure. Thus, the present invention is not to be construed as limited by the embodiments described above and various modifications and changes can be made without departing from the scope of the claims. For example, a plurality of constituent blocks described in the configuration diagrams of the embodiments can be combined into one or one constituent block can be divided.

### REFERENCE SIGNS LIST

1 Target object (first target object)
2 Structure (second target object)
10, 10a, 10b Laser Doppler vibrometer (LDV)
11 Laser light source
12, 13, 16 Beam splitter
14 Mirror
15 Frequency converter
17 Optical receiver
18 Electrical signal processing unit
20 Electrical signal processing apparatus
100, 100A, 100B, 100C, 100D, 100E, 100F Measurement apparatus
110 Main body
111 Light reception unit
112, 113, 116 Half mirror
114 Mirror
115 Frequency converter
117 Optical receiver
118 Electrical signal processing unit
120 Optical branch unit
121 Beam splitter
122 Optical path converter
123 Half mirror
124, 124a, 124b Total reflection mirror
130 Selection unit
131, 132 Shutter
141 Phase adjuster
142 Optical attenuator
143 Adjustment unit
161 Beam splitter
117a First optical receiver
117b Second optical receiver

1. A measurement apparatus comprising:
a laser light source;
a beam splitter configured to branch laser light emitted from the laser light source into first branch light and second branch light and irradiate a first target object with the first branch light;
an optical path converter configured to convert a direction of the second branch light to a direction in which a second target object is irradiated with the second branch light and irradiate the second target object with the second branch light; and
a light reception unit configured to receive first reflected light obtained in a manner that the first branch light is reflected by the first target object and second reflected light obtained in a manner that the second branch light is reflected by the second target object.

2. The measurement apparatus according to claim 1, further comprising:
a selection unit configured to individually select an incidence of the first reflected light and the second reflected light to the light reception unit.

3. The measurement apparatus according to claim 1, wherein
the optical path converter is provided to allow an irradiation position of the second branch light to be adjusted.

4. The measurement apparatus according to claim 1, further comprising:
an adjustment unit provided between the beam splitter and the optical path converter and configured to allow at least one of a phase or an amplitude of light propagating between the beam splitter and the optical path converter to be adjusted.

5. The measurement apparatus according to claim 1, further comprising:
an optical modulator provided between the laser light source and the beam splitter and configured to modulate the laser light.

6. The measurement apparatus according to claim 1, further comprising:
an optical system configured to shift a first optical axis of the first reflected light incident to the light reception unit and a second optical axis of the second reflected light incident to the light reception unit, wherein
the light reception unit includes a first optical receiver and a second optical receiver,
the first optical receiver receives the first reflected light, and
the second optical receiver receives the second reflected light.

7. The measurement apparatus according to claim 1, wherein
the measurement apparatus includes
a main body including at least the laser light source and the light reception unit, and
an optical branch unit including at least the beam splitter and the optical path converter, and
the optical branch unit is provided to be rotatable about the first optical axis of the first branch light or the second optical axis of the second branch light emitted from the measurement apparatus, with respect to the main body.

8. A measurement method in a measurement apparatus including a laser light source and a light reception unit, the measurement method comprising:
branching laser light emitted from the laser light source into first branch light and second branch light and irradiating a first target object with the first branch light;
converting a direction of the second branch light to a direction in which a second target object is irradiated with the second branch light and irradiating the second target object with the second branch light; and
receiving, by the light reception unit, first reflected light obtained in a manner that the first branch light is reflected by the first target object and second reflected light obtained in a manner that the second branch light is reflected by the second target object.
